(19) United States
(12) Patent Application Publication
(10) Pub. No.: US 2026/0296599 A1
(43) Pub. Date: Oct. 1, 2026

(54) INTEGRATED TENSIONER

(71) Applicant: Kongsberg Maritime AS, Alesund (NO)

(72) Inventors: Terje NISTAD, Oslo (NO); Magnus ROSVOLL, Alesund (NO)

(73) Assignee: Kongsberg Maritime AS, Alesund (NO)

(21) Appl. No.: 19/488,905

(22) PCT Filed: May 31, 2024
(86) PCT No.: PCT/NO2024/050127

§ 371 Date: Dec. 1, 2025

(30) Foreign Application Priority Data
Jun. 2, 2023 (NO) 20230635

(51) Int. Cl. B63B 21/04; B63B 21/16; B63B 35/44; B63B 35/68

(52) U.S. Cl. CPC B63B 21/04; B63B 21/16; B63B 35/44; B63B 35/68; B63B 2035/446

(57) ABSTRACT

It is disclosed a system (1) and a method for hook-up and tensioning of a floating wind turbine to the seabed. The floating wind turbine comprising at least one mooring line (3) adapted for mooring the floating wind turbine to the seabed. An installation vessel is provided with a dynamic positioning (DP) system and a winch (6), wherein the winch (6) is adapted for controlling a mooring line (3)/installation line (18). A tensioner is adapted for the mooring line/installation line. Controlling at least one of the winch and the dynamic positioning system on the installation vessel based on at least one input parameter for hook-up and tensioning of the at least one mooring line of the floating wind turbine to the seabed.

### PRIOR RELATED APPLICATIONS

The present application is a national entry of PCT Application No. PCT/NO2024/050127, filed on May 31, 2024, which claims priority to Norwegian Application NO 20230635, filed on Jun. 2, 2023. The entire contents of such prior applications are incorporated by reference herein.

### INTRODUCTION

The present invention concerns hook up and tensioning operations for a floating installation by use of an installation vessel. The floating installation may be a floating wind turbine (FWT).

### BACKGROUND

Floating wind turbines (FWT) are moored to the seabed by at least one mooring line. The mooring line(s) are moored to the seabed in a hook-up and tensioning process. The standard method to perform hook-up and tensioning of mooring lines for a floating installation by an installation vessel in the oil&gas sector is to use the winches onboard the floating installation and pull-in a chain/wire to pre-defined lengths and pretension. Some of the recent hook-ups of floating offshore wind turbines (FWT) have been done with the use of a tensioner on the last mooring line that is hooked-up. The tensioning method is to pull in an extra mooring segment through the tensioner to ensure tension level within required tolerances for the complete mooring system. The present methods for hook up and tensioning may require personnel onboard the floating installation for parts of the installation process. The present methods for tensioning using winches on vessels for installation of floating offshore wind turbines (FWT) have limited functionality. In general anchor handling vessels are not equipped with sufficient winch systems to compensate for motions in higher sea states and high tensions in mooring lines. For floating wind turbines going from demonstration and pilot projects to large-scale developments there is an industry need to develop new and improved methods to perform hook-up and tensioning of the mooring lines of floating wind turbines. There is a need for cost efficient methods with the possibility for operation in higher weather criteria (higher waves, more wind etc.) providing an increased operation time and reduced weather down time and at the same time with increased safety during the hook-up and tensioning process for installation of the mooring lines of the floating installation e.g. FWT to the seabed.

### SUMMARY OF THE INVENTION

The invention provides a system for hook-up and tensioning of a floating wind turbine to the seabed, the system comprising:
a floating wind turbine comprising at least one mooring line adapted for mooring the floating wind turbine to the seabed;
an installation vessel comprising a dynamic positioning (DP) system and a winch, wherein the winch is adapted for controlling a mooring line/installation line; and
a tensioner adapted for the mooring line/installation line;
   wherein the system being adapted for controlling at least one of the winch and the dynamic positioning system on the installation vessel based on at least one input parameter for hook-up and tensioning of the at least one mooring line of the floating wind turbine to the seabed.

The system may be adapted for controlling at least one of the winch and the dynamic positioning system on the installation vessel based on at least a position of the floating wind turbine and a position of the vessel. The system may be adapted for controlling at least one of the winch and the dynamic positioning system on the installation vessel based on at least a motion of the floating wind turbine and a motion of the vessel.

The system may be adapted for compensating for a relative movement between the floating wind turbine and the installation vessel during the hook-up and tensioning operation by at least one of the winch or the dynamic positioning system of the installation vessel. The at least one of the winch and the dynamic positioning system on the installation vessel may be adapted for compensating for a relative movement between the floating wind turbine and the installation vessel. The system may be configured to compensate for at least one of lateral, vertical, and rotational movements between the floating wind turbine and the installation vessel during the hook-up and tensioning operation by controlling the winch or the dynamic positioning system of the installation vessel. The system may compensate for relative motions in 6 DOF.

The system may be adapted for controlling at least one of the winch and the dynamic positioning system on the installation vessel for controlling at least one of a length or a tension or a winch speed of the installation line/mooring line during the hook-up and mooring operation. The system may be configured to control the winch and the dynamic positioning system based on tension sensor feedback and a specified length parameter for the installation line/mooring line during the hook-up and mooring operation.

The floating wind turbine may comprise at least one position sensor for measuring a position of the floating wind turbine. The floating wind turbine may comprise at least one motion sensor for measuring a motion of the floating wind turbine. The floating wind turbine may comprise a wireless communication system adapted for transmitting sensor information to the installation vessel. The installation vessel may comprise at least one position sensor for measuring a position of the installation vessel. The installation vessel may comprise at least one motion sensor for measuring a motion of the installation vessel. The installation vessel may comprise a wireless communication system adapted for receiving sensor information from the floating wind turbine. The floating wind turbine may further comprise at least one inertial navigation system (INS). The inertial navigation system (INS) may provide data for determining the floating wind turbine's heading, speed, and rotation. The floating wind turbine may further comprise at least one of a satellite navigation system or an inertial measurement unit (IMU). The satellite navigation system may provide geo-positioning data of the floating wind turbine.

The inertial measurement unit may be at least one of a motion reference unit (MRU) and a motion gyro compass (MGC). The wireless communication system may be a marine broad band radio (MBR).

In a further aspect, the invention provides an installation vessel for performing a hook-up and tensioning operation for mooring at least one mooring line of a floating wind turbine to a seabed by use of a tensioner for the mooring line/installation line, the vessel comprising a dynamic positioning (DP) system and a winch, wherein at least one of the winch and the dynamic positioning system is adapted for controlling the installation line/mooring line of the floating wind turbine based on at least one input parameter for hook-up and tensioning of the at least one mooring line of the floating wind turbine to the seabed.

The installation vessel may be adapted for compensating a relative movement between the floating wind turbine and the installation vessel during the hook-up and tensioning operation. The installation vessel may be adapted for controlling at least one of the winch and the dynamic positioning system on the installation vessel based on at least a position of the floating wind turbine and a position of the vessel. The installation vessel may be adapted for controlling the at least one of the winch and the dynamic positioning system on the installation vessel based on at least the motion of the floating wind turbine and the motion of the installation vessel. The installation vessel may be adapted for compensating a relative movement between the floating wind turbine and the installation vessel during the hook-up and tensioning operation by at least one of the winch or the dynamic positioning system of the installation vessel. The installation vessel may be adapted for controlling at least one of the winch and the dynamic positioning system on the installation vessel for controlling at least one of a length or a tension or a winch speed of the installation line/mooring line during the hook-up and mooring operation. The installation vessel may comprise at least one position sensor for measuring a position of the installation vessel. The installation vessel may comprise at least one motion sensor for measuring a motion of the installation vessel. The installation vessel may comprise a wireless communication system adapted for receiving sensor information from the floating wind turbine. The sensor information may comprise as least one of a position and a motion of the floating wind turbine. The wireless communication system may be a marine broad band radio (MBR).

In a further aspect, the invention provides a floating wind turbine comprising at least one mooring line adapted for mooring the floating wind turbine to the seabed, at least one sensor; and a wireless communication system adapted for transmitting sensor information to an installation vessel adapted for hook-up and tensioning of the at least one mooring line of the floating wind turbine to the seabed. The floating wind turbine may comprise at least one position sensor for measuring a position of the floating wind turbine. The floating wind turbine may comprise at least one motion sensor for measuring a motion of the floating wind turbine. The floating wind turbine may comprise a wireless communication system adapted for transmitting sensor information to the installation vessel. The floating wind turbine may further comprise at least one inertial navigation system (INS). The floating wind turbine further may further comprise at least one of a satellite navigation system or an inertial measurement unit (IMU). The inertial measurement unit may be at least one of a motion reference unit (MRU) and a motion gyro compass (MGC). The wireless communication system may be a marine broad band radio (MBR).

In a further aspect, the invention provides a hook-up and tensioning module for controlling a hook-up and tensioning operation for mooring of a floating wind turbine by an installation vessel by use of a vessel tensioner, the floating wind turbine having at least one mooring line to be moored to the seabed, the module comprising an interface configured to receive data from a dynamic positioning system and a winch on the installation vessel, and a control system configured to adjust the operation of the winch and the dynamic positioning system based on the received data. The data may comprise at least one input parameter from a floating wind turbine. The at least one input parameter from the floating wind turbine may comprise a position of the floating wind turbine. The data may comprise winch operation information from the vessel winch. The data may comprise information from the dynamic positioning system of the installation vessel. The control system may be adapted for controlling at least one of the winch and the dynamic positioning system on the installation vessel based on at least the position of the floating wind turbine and the position of the vessel for controlling at least one of a length or a tension or a winch speed of the installation line/mooring line during the hook-up and tensioning operation. The data may be real-time data or near real-time data.

The invention provides in an aspect, a method for hook-up and tensioning of at least one mooring line of a floating wind turbine to a seabed by an installation vessel, the method comprising use of a tensioner and further controlling at least one of a winch and a dynamic positioning system on the installation vessel based on at least one input parameter. The method may further comprise controlling at least one of the winch and the dynamic positioning system on the installation vessel based on at least the position of the floating wind turbine and the position of the vessel. The method may further comprise controlling the at least one of the winch and the dynamic positioning system on the installation vessel based on at least the motion of the floating wind turbine and the motion of the vessel. The method may further comprise compensating a relative movement between the floating wind turbine and the installation vessel during the hook-up and tensioning operation by at least one of the winch or the dynamic positioning system of the installation vessel. At least one of the winch and the dynamic positioning system on the installation vessel may be adapted for compensating a relative movement between the floating wind turbine and the installation vessel during the hook-up and tensioning operation. The method may further comprise controlling at least one of the winch and the dynamic positioning system on the installation vessel for controlling at least one of a length or a tension or a winch speed of the installation line/mooring line during the hook-up and tensioning operation based on at least the position of the floating wind turbine and the position of the vessel.

The present invention provides tensioners in a combination with a winch with integrated control systems installed on a vessel operated on DP equipped to perform hook-up and tensioning of mooring lines on floating wind turbines (FWTs). Instrumentation installed on the FWTs to perform hook-up and tensioning of mooring lines from a vessel operated on DP provides a solution without the need for personnel transfer to the FWT and without a need for a winch onboard the FWT.

The integrated functionality of the present invention ranges from optimized tensioner design to winch design and controllers including integration with the dynamic position system onboard the vessel and sensors involved in the hook-up and tensioning operation.

This functionality provides an efficient installation solution reducing the cost (LCOE) for large scale floating wind developments. The concept reduces/eliminates the need for winches on the floater. The invention also enables increased hook-up weather window & optimized operational efficiency. The integrated functionality enables the hook-up and tensioning module to advice an operator and provide control input to the vessel DP system and winch control system based on predetermined parameter levels.

The built-in functionality provided by the pull-in and hook-up functionality of the invention may be customized for different operations, including not only installation of FWT, but also for operations including mooring line and anchor installation of other floating installations.

### BRIEF DESCRIPTION OF DRAWINGS

Example embodiments are described with reference to the following drawings, where:

FIG. 1 illustrates an exemplary floating wind turbine and an installation vessel and use of an integrated tensioner in the form of a vessel tensioner for hook-up and tensioning of at least one line to a target tension for mooring the floating wind turbine.

FIG. 2 illustrates an exemplary floating wind turbine and an anchored installation vessel and use of an integrated tensioner in the form of a vessel tensioner for hook-up and tensioning of at least one line to a target pretension for mooring the floating wind turbine.

FIG. 3 illustrates an exemplary floating wind turbine and an installation vessel and use of an integrated tensioner in the form of an inline tensioner for hook-up and tensioning of at least one line to a target pretension for mooring the floating wind turbine.

FIG. 4 illustrates an exemplary floating wind turbine and an installation vessel and use of an integrated tensioner in the form of a seabed tensioner for hook-up and tensioning of at least one line to a target pretension for mooring the floating wind turbine.

FIG. 5 illustrates the floating part (pontoon) of a floating wind turbine provided with equipment for performing a hook-up and tensioning process by an installation vessel.

FIG. 6 illustrates exemplary steps in a hook-up & tensioning procedure with a

FIG. 7 illustrates exemplary steps in a hook-up & tensioning procedure with an inline tensioner.

FIG. 8 illustrates exemplary steps in a hook-up & tensioning procedure with a seabed tensioner.

FIG. 9 illustrates exemplary steps in a hook-up & tensioning procedure with a vessel tensioner and an anchored installation vessel.

FIG. 10 illustrates exemplary steps in a hook-up & removing construction stretch procedure with a vessel tensioner and an anchored installation vessel in particular for fiber lines.

FIG. 11 illustrates an exemplary concept integration between vessel instrumentation, vessel winch, floater instrumentation, vessel integrated tensioner master system and vessel DP system.

FIG. 12 illustrates an exemplary enhanced DP functionality provided by the vessel integrated tensioner master system. An operation limit in the form of an allowed sector (as illustrated) for the installation vessel is calculated by the vessel integrated tensioner master system and provided to the DP system of the installation vessel.

FIG. 13 illustrates an exemplary vessel winch system with a winch HMI (human monitor interface), DP HMI (human monitor interface) and a vessel integrated tensioner master HMI (human monitor interface) provided on the bridge of the installation vessel.

FIG. 14 illustrates an exemplary vessel integrated tensioner master, DP and Winch Control with human monitor interface (HMI) and at least one human operator for these systems.

FIG. 15 illustrates an exemplary vessel tensioner attached to a floating wind turbine.

### DETAILED DESCRIPTION

Example embodiments are disclosed with reference to the drawings. The same reference numerals are used for the same or similar features in all the drawings and throughout the description. The example embodiments are examples only and are not limiting for the invention.

The following disclosure is provided for installation of a floating wind turbine (FWT), in particular an offshore floating wind turbine. The disclosure may however also apply for installation of other floating constructions by hook-up and tensioning by use of an installation vessel.

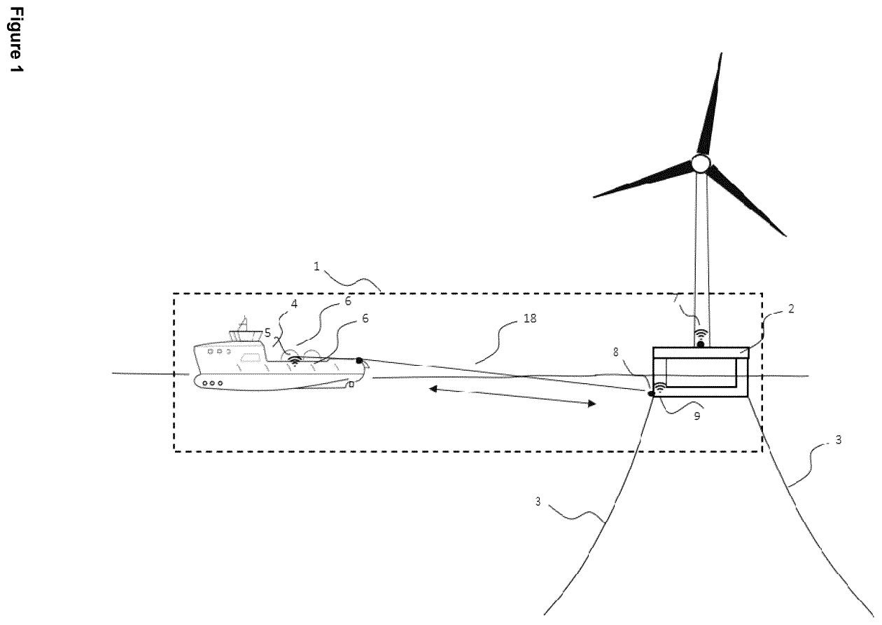

FIG. 1 illustrates a floating wind turbine 2 and an installation vessel 4. The installation vessel may e.g. be an anchor handling vessel. A floater instrumentation kit 7 may be placed on the floating wind turbine to transmit the required status data wirelessly to the installation vessel.

The instrumentation kit may be provided in a compact unit placed on the FWT. The instrumentation kit may be removable from the FWT. The floater instrumentation kit may include at least one sensor. The floater instrumentation kit has a wireless transmitter for transmitting sensor information to the installation vessel. The floating wind turbine (FWT) is provided with at least one mooring line, preferably minimum three mooring lines, to be hooked up and tensioned for safely securing the FWT to the seabed. An installation line is attached between a winch wire for a winch on the installation vessel and the mooring line. The tensioning method pulls in an extra mooring line segment through a tensioner to ensure a mooring line tension within the required tolerances for the complete mooring system for the FWT.

### Tensioners

The tensioner in this disclosure is a device with many similar functionalities as a fairlead on an offshore rig; guide a line around an object (here e.g. chain/wire wheel) to be used for tensioning and stop the line from moving laterally. However, the tensioner uses a vessel winch during hook-up and tensioning and eliminates the use of mooring winches mounted on the FWT.

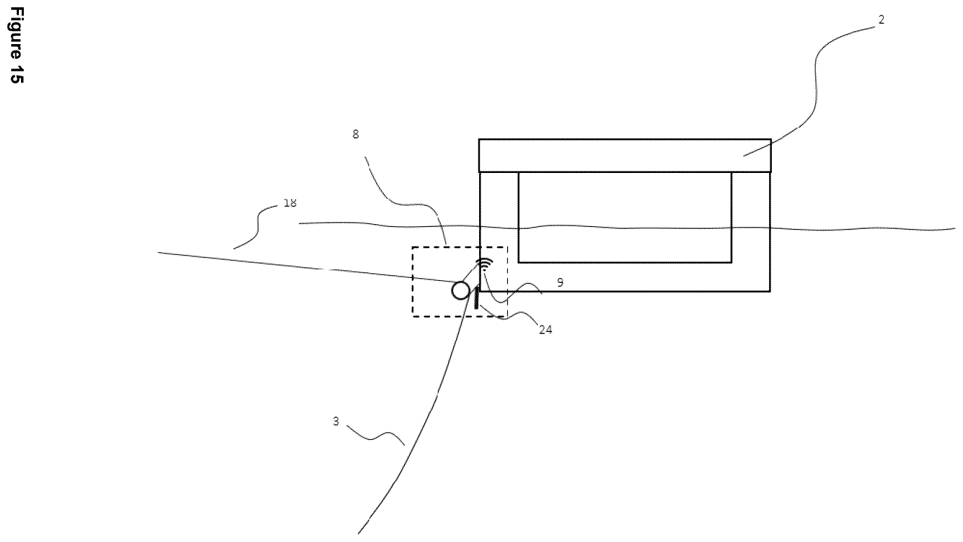

The mooring line is secured in the tensioner when target tension for the mooring system is reached. The mooring line may be secured by a pawl acting as a chain stopper, ref FIG. 15. In addition to open and closing modes it may also be designed as a ratchet. The pawl acts thus as a ratchet, and each chain link is secured in a click-clack manner.

The vessel tensioner is a combined fairlead, chain stopper and tensioning device, ref FIG. 1. The vessel tensioner is mounted on the hull of the FWT. The vessel winch line is thread through the tensioner and connected to the FWT mooring line during the tensioning operation.

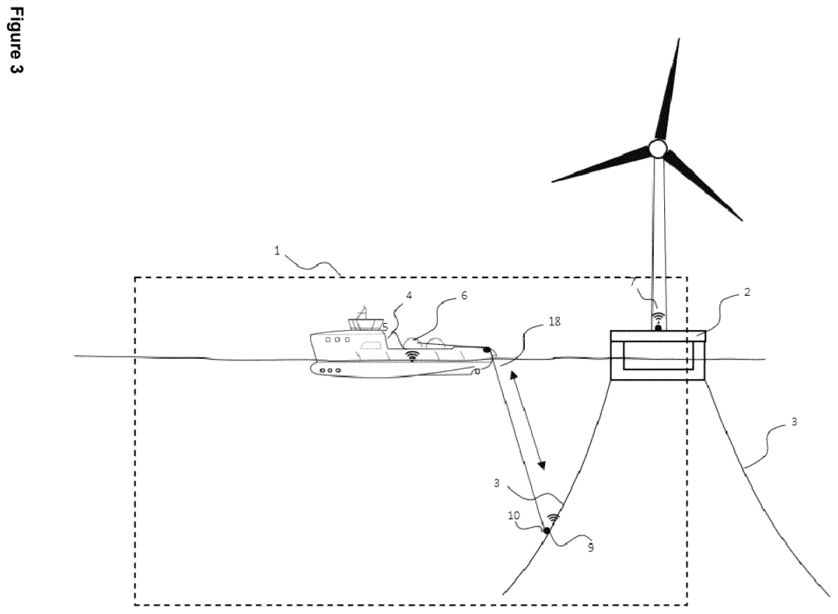

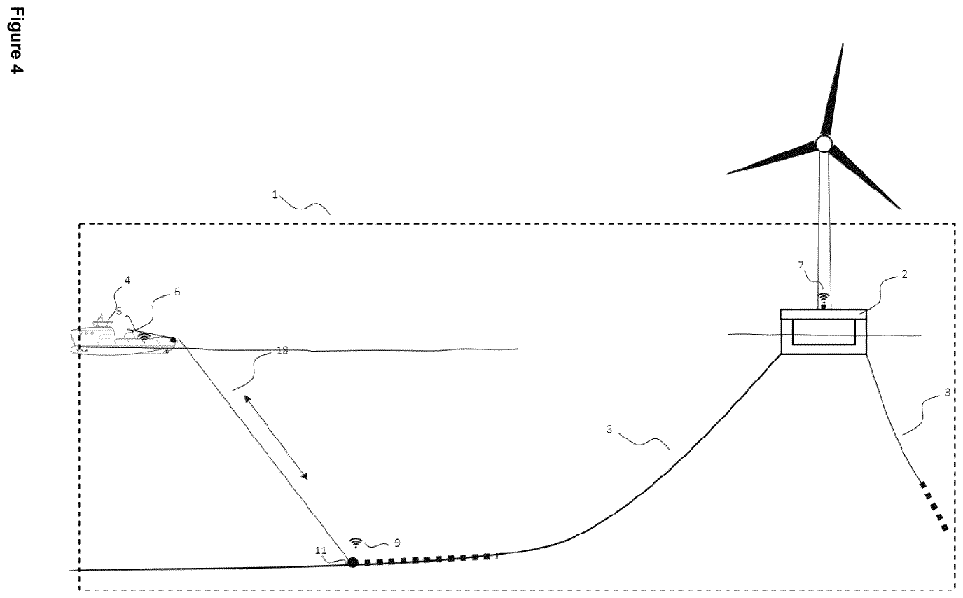

The inline tensioner and seabed tensioner combines chain securing and tensioning, ref FIGS. 3 and 4. They are connected to one end of the FWT mooring line. The other FWT mooring line end is connected to the vessel winch line and pulled through the tensioner by using the vessel winch to adjust the tension.

The tensioner to be used depends on the operational requirements. A vessel tensioner is mounted to the floating construction. An inline tensioner is mounted on the mooring line 3. A seabed tensioner is mounted on the mooring line 3 in a position towards the anchor. The use of at least one tensioner eliminates the need for onboard floater winches since the hook-up and tensioning may be performed by an external vessel; i.e. an installation vessel. The installation line/mooring line is pulled through the tensioner to ensure a tension level within the required tolerances for the complete mooring system of the floating construction. The pawl of the tensioner should be able to be opened and closed during the operation. When the tensioner is closed the length of the installation line and/or mooring line is fixed. When the tensioner is open, the tension/length of the installation line and/or mooring line may be controlled. The tensioner may be remotely operated, e.g. wirelessly, for opening and closing of the tensioner. The tensioner may be manually operated for opening and closing/locking of the tensioner.

The optimal tensioner may depend of several factors, such as available vessel spread, water depth, anchor radius and creep removal in fibre ropes if required.

All tensioners can be set-up with remote control, e.g. an acoustic signal. This remote control enables opening and closing the pawl by activating a hydraulic backpack. The engagement of the hydraulic backpack is done by transmitting an acoustic signal.

### Installation Vessel

The installation vessel is provided with a dynamic positioning system. Dynamic positioning (DP) involves automatic or semi-automatic control of a vessel's position and heading by using its own propellers and thrusters with respect to one or more position references. The dynamic positioning (DP) system may keep the position of a vessel fixed within given parameters or manoeuvre the vessel in a way that it could not do without the dynamic positioning system. A dynamic positioning (DP) system may manoeuvre a vessel based on a number of input parameters. These input parameters may e.g. come from:
sensors for location, heading, speed on the vessel;
sensors for external factors such as wind, waves, current; and
input from a user to execute a mission such as maintain position or move in a particular pattern.

The input from a user may e.g. be provided from an external control centre, from another vessel, from a captain onboard the vessel or via an interface from another system. The captain may input the mission data in a number of ways, including manually by use of mouse, on screen, voice etc.

Control algorithms of the dynamic positioning (DP) system takes in the sensor and user input parameters and executes manoeuvre of the vessel by controlling the on-board propellers and thrusters even with changes in external forces.

The DP system may be adapted for controlling the vessel based on at least one first input parameter which may comprise at least one of:
position of the floating wind turbine;
position of the vessel;
heading of the vessel;
thruster force of the vessel;
motions of the floating wind turbine including at least one of heave, sway, surge, roll, pitch and yaw;
motions of the vessel including at least one of heave, sway, surge, roll, pitch and yaw;
tension in the installation line/mooring line;
length of the installation line/mooring line;
winch tension;
output from the winch control system of the vessel;
operational limits for the installation vessel;
advised position for the installation vessel.

A winch control system may be adapted for controlling the winch on the installation vessel based on at least one second input parameter, which may comprise at least one of:

position of the floating wind turbine;
position of the installation vessel;
motions of the floating wind turbine including at least one of heave, sway, surge, roll, pitch and yaw;
motions of the installation vessel including at least one of heave, sway, surge, roll, pitch and yaw;
position of the installation line/mooring line; and
tension in the installation line/mooring line;
catenary of the installation line;
output from the DP system of the installation vessel;
relative distance between floating wind turbine and installation vessel.

The winch special enhanced mission execution functionality may compensate for the movement between the installation vessel and the FWT depending on the situation and mission functionality by paying out or paying in the installation line/mooring line.

The winch control system on the installation vessel is provided with a special enhanced mission execution functionality providing speed/length/tension set point for the winch. The special enhanced mission execution functionality of the winch control system may be dependent on chosen controller mode. The winch could compensate for floater and vessel motions to optimize the tension operation and keep controller parameters such as pull in speed, wire length, winch tension within target values.

### Sensor Kit on Floating Wind Turbine (FWT)

As explained above, a minimal standalone sensor kit can be placed on the floating wind turbine FWT and required status data transmitted wirelessly to the installation vessel.

Floater instrumentation kit 7 is described in detail below. The instrumentation kit may be provided in a compact unit placed on the FWT. The instrumentation kit may be removable from the FWT. The instrumentation kit may include at least one sensor for measuring a position of the floater. The instrumentation kit may include at least one sensor for measuring a speed, motion, and an acceleration, and a position of the floater. The instrumentation kit may e.g. include: a differential GPS for position measurements of the floater; a motion sensor and gyro compass for measuring roll, pitch, heave, heading, 6-DOF speed and acceleration; a Maritime Broadband radio for wireless transmission with the installation vessel and battery or regular power supply providing power to the instrumentation kit components.

An Example of an instrumentation kit installed on the floating wind turbine is explained below.

The floating wind turbine may be provided with an Inertial Navigation System (INS) 12. The Inertial Navigation System 12 may include at least one of a satellite navigation system (e.g. Global Navigation Satellite System (GNSS) or GPS) and an Inertial Measurement Unit (MRU or MGC) to measure position and movements of the floating wind turbine 2. The satellite navigation system may e.g. be GNSS, GPS, GLONASS, BeiDou, Galileo, QZSS, IRNASS or NavIC. This enables monitoring of the floating wind turbine's movements in 6 DOF (degrees of freedom); i.e. heave, sway, surge, roll, pitch and yaw. The floating wind turbine 2 may further be provided with a communication system (transceiver) 13 for communication of the signals from the floating instrumentation, e.g. signals from the Inertial Navigation System (INS) and sensors onboard the floating wind turbine to the installation vessel. The communication system may e.g. be a Marine Broadband Radio (MBR), but other wireless communication systems may also be used. The instrumentation on the FWT may be pre-installed. The installation on the FWT may be removable.

A first sensor for measuring the distance between the floating wind turbine and a installation vessel may be provided on the FWT and/or the installation vessel. The first sensor may typically be a distance sensor. The distance sensor may be an optical sensor. The optical sensor may be a laser or IR sensor. Other distance sensors like radar or ultrasound may also be used depending on the system and system requirements.

A relative movement between the installation vessel 4 and the floating wind turbine 2 may alternatively be estimated indirectly by using data from at least two sensors, where at least one sensor is arranged on the installation vessel 4 and at least one sensor is arranged on the floating wind platform 2. The at least two sensors may be absolute position sensors.

The system may be provided with at least one inertial navigation system (INS) 12, which may be a satellite navigation system or an inertial measurement unit. The inertial measurement unit may be at least one of a motion reference unit (MRU) and a motion gyro compass (MGC).

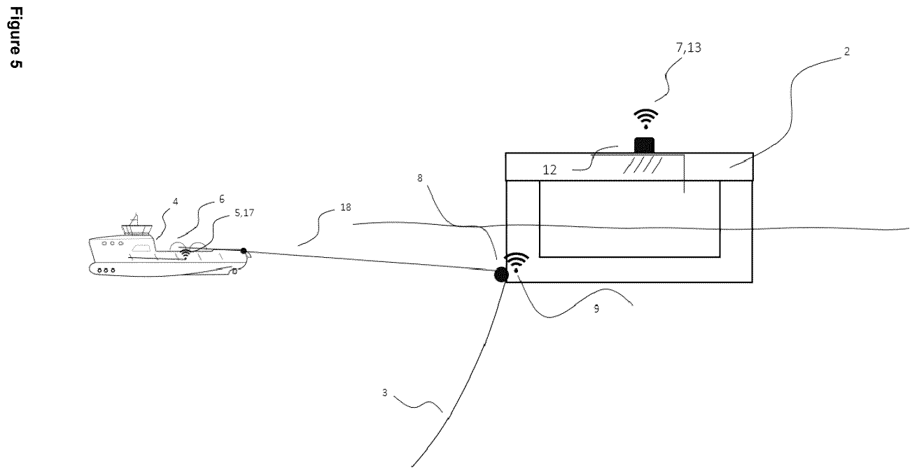

FIG. 5 illustrates an example of the floating part (pontoon) of a floating wind turbine provided with floater instrumentation kit 7 and a vessel tensioner attached to the FWT. The instrumentation kit on the FWT includes Inertial Navigation System (INS) sensor 12 and a Marine Broadband Radio (MBR) to transfer INS sensor information to the installation vessel. Inertial Navigation System (INS) sensor 12 may include Global Navigation Satellite System (GNSS) sensor and Inertial Measurement Unit (MRU or MGC) sensor to measure FWT position and movements. The installation vessel 4 is provided with Inertial Measurement Unit (MRU or MGC) sensor 17 to measure installation vessel motions. The Inertial Measurement Unit sensor 17 is in FIG. 5 arranged on the winch. As the winch is provided with an Inertial Measurement Unit (MRU or MGC), increased accuracy of the position and movement of the winch onboard the installation vessel is achieved providing improved compensation for the motions of the installation vessel for the winch. The Inertial Measurement Unit (MRU or MGC) may be provided on the winch for all the example embodiments presented in this disclosure.

### Vessel Tensioner

In the illustrated situation in FIG. 1 the FWT is in the final mooring position and the last cluster/last line(s) 3 are to be picked up from the seabed and pulled-in and coupled up to a target pretension. For a FWT moored by use of three lines, the last line may be one line, for a total of six lines, the last lines may be two lines, and for a total of nine lines the last lines may be three lines. The installation vessel is provided with a winch 6 for pulling in the installation line 18 to be hooked-up and tensioned. The winch 6 may be controlled by a winch control system. The installation line may be a fiber line, a wire or a chain. The mooring line may be a fiber line, a wire or a chain or a combination of at least two of these. The installation line 18 is connected to the mooring line. The installation line 18 may be controlled by the winch 6. In FIG. 1, the installation line leaves the installation vessel over the aft of the installation vessel. The installation line passes a tensioner 9 attached to the FWT. The tensioner is in FIG. 1 attached to a lower part of one of the floating elements of the FWT 2. The tensioner may be provided with a hydroacoustic or hydraulic open/closure mechanism of the PAWL. The hydroacoustic or hydraulic open/closure mechanism may be remote controlled, e.g. wirelessly or wired remote controlled. The tensioner may be a vessel tensioner. During the hook-up and tensioning of the mooring line, the installation vessel and the mooring line should be controlled with respect to the relative motion between the FWT and the installation vessel. This increases the safety of the operation. Control of the installation vessel in view of the FWT also enables operation in higher weather criteria.

The FWT is provided with a floater instrumentation kit 7 for sensing at least one parameter and communicating this at least one parameter to the installation vessel 4. The at least one parameter may be a position of the FWT. The at least one parameter may be a global position of the FWT. The at least one parameter may be a movement of the FWT. The installation vessel is provided with vessel instrumentation 5. The floater instrumentation kit 7 may transmit information from the sensor(s) of the instrumentation kit to the vessel instrumentation 5 on the installation vessel. The vessel instrumentation may measure the position of the vessel. The vessel instrumentation may measure the movement of the installation vessel. The winch special enhanced mission execution functionality may compensate for the movement between vessel and tensioner depending on the situation and mission functionality by paying out or paying in the installation line/mooring line. The DP system special enhanced mission execution functionality may compensate for movement between the installation vessel and the FWT by controlling the position and heading of the installation vessel depending on the situation and mission functionality. Both the winch and the DP system may work together for compensating the movement between the installation vessel/tensioner and the FWT. Depending on the situation and mission functionality the position and heading of the installation vessel and the pay-out/pay-in of the installation line may be controlled simultaneously.

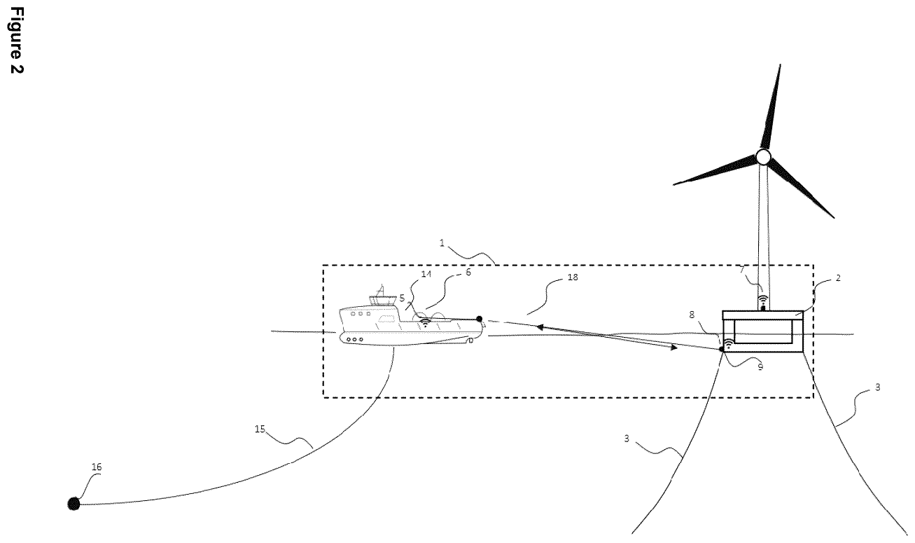

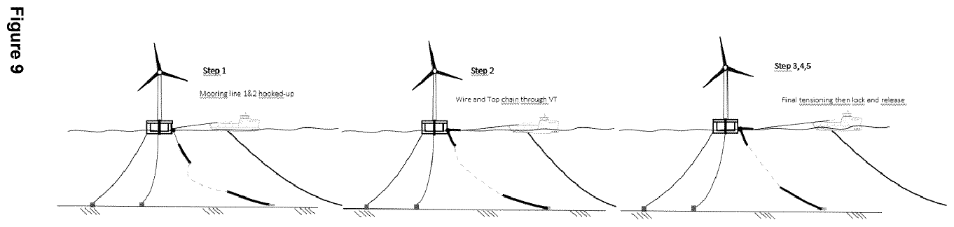

FIG. 2 illustrates a floating wind turbine 2 and an anchored 16 installation vessel 14. The vessel is provided with a winch 6 and vessel instrumentation as explained above. The FWT is provided with an instrumentation kit 7 as explained above. The anchor 16 may be a separate anchor or connected to the anchor for the mooring line 3. FIG. 2 provides the same situation as in FIG. 1, where the FWT is in the final mooring position and the last cluster/last line(s) 3 are to be picked up from the seabed and pulled-in and coupled up to a target pretension. The anchor provides assistance to the DP system on the installation vessel. The mission functionality of the DP system would behave differently in a situation with a reaction anchor than in the situation in FIG. 1. The anchor allows for a harder pull and a very high tension of the mooring line. This is particularly useful when pulling up construction stretch removal as illustrated in FIG. 9. Use of the reaction anchor also saves fuel for the installation vessel. In case of failure in the reaction anchor, a failure mode is provided to avoid contact between the installation vessel and the floater. If the anchor fails, the DP system will assist to prevent contact with FWT together with the winch that pays out the installation line/mooring line. The DP system may assist in case of winch failure and the winch may assist in case of DP system failure.

### Inline Tensioner

FIG. 3 illustrates a floating wind turbine 2 and a floating installation vessel 4. The inline tensioner 10 is connected to the mooring line 3. The vessel is provided with a winch 6 and vessel instrumentation 5 as explained above. The FWT is provided with an instrumentation kit 7 as explained above. The installation vessel is positioned above the inline tensioner resulting in a small angle provided by the installation line 18 from a position over the aft of the vessel and down to the inline tensioner and a vertical direction as illustrated in FIG. 3. The small angle requires less bollard pull of the installation vessel for the hook-up and tensioning of the mooring line. The installation line 18 pulls the mooring line 3 through the inline tensioner. As the installation vessel is positioned above the inline tensioner, control of the length of the installation line provides the tension in the mooring line. The length of the installation line is controlled by the vessel winch based on the position and movement of the FWT, thereby controlling the tension in the mooring line during the hook-up and tensioning operation. The DP system controls the position and heading of the installation vessel based on the position and movement of the FWT to maintain the installation vessel position above the inline tensioner. A vessel integrated tension master control system may control the vessel DP system and the vessel winch based on the position and movement of the FWT and the position and the movement of the installation vessel. The position and movement information of the FWT is received by the vessel integrated tension master control system from the FWT instrumentation kit 7 via a wireless transmission. The position and movement of the installation vessel is received by the vessel integrated tension master control system from the instrumentation. The system integration will be explained in detail later. The solution providing control of the winch based on sensor information from the FWT and from the vessel increases the installation criteria for the hook-up and tensioning procedure and enables performing the procedure in bad weather conditions.

### Seabed Tensioner

FIG. 4 illustrates an exemplary floating wind turbine and an installation vessel and use of an integrated tensioner in the form of a seabed tensioner for hook-up and tensioning of at least one line to a target pretension for mooring the floating wind turbine. FIG. 4 illustrates a floating wind turbine 2 and a floating installation vessel 4. The seabed tensioner 11 is connected to the mooring line 3. The vessel is provided with a winch 6 and vessel instrumentation 5 as explained above. The FWT is provided with an instrumentation kit 7 as explained above. The installation vessel is positioned away from the seabed tensioner position such that the angle defined by the installation line 18 as shown in FIG. 4 and by the vertical direction going through the seabed tensioner 11, is relatively large as compared to the inline tensioner as explained above. The position of the FWT is less important than for use of an inline tensioner. Both the pull by the winch and the positioning of the installation vessel ensure the installation vessel maintains a relatively large angle during the hook-up and tensioning procedure. A vessel integrated tension master control system may control the vessel DP system and the vessel winch based on the position and movement of the FWT and the position and the movement of the installation vessel as explained above for FIG. 3.

### Removal of Construction Stretch (SCR)

The disclosed concept is planned used during hook-up operation of a floating wind turbine. This is to ensure that the final pretension level in the mooring lines is within required limitations set by the operator. If the mooring system is designed with fibre lines such as polyester or similar type of ropes, construction stretch must be removed from the system during the hook-up operation before the pretension target is reached.

Adjusting the pay-out of the top chain is most likely required due to the phenomenon of construction stretch in the fibre rope. The fibre rope elongates itself over the course of time due to being subject to tension over a prolonged period. It is deemed that this phenomenon is especially pronounced for polyester ropes. It is required to pull in mooring line through the Tensioners to reach a tension up to typically about 40% maximum of MBL of the mooring line and subsequently it will be most like required to pull out mooring line to reach the final pre-tension.

The CSR operation is most likely performed by AHTs vessel. However, existing fleet with AHTS and current methods will make it difficult to achieve high tensions of e.g. hundreds of tons.

### System Integration

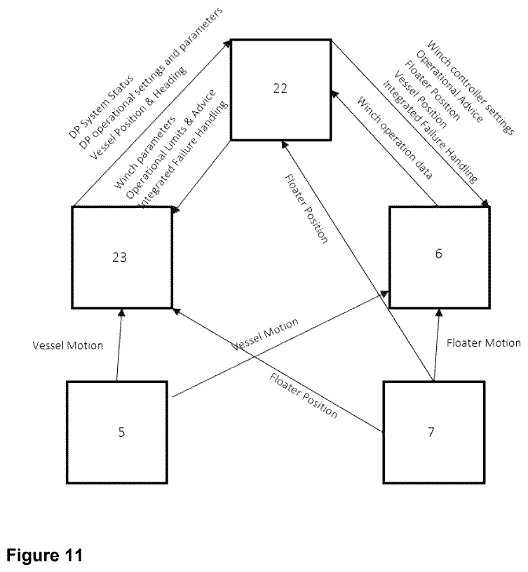

FIG. 11 illustrates an exemplary concept integration between vessel instrumentation, vessel winch, floater instrumentation, vessel integrated tensioner master system and vessel DP system.

Vessel instrumentation 5 transfer data related to vessel motion to vessel DP system 23 and to the vessel winch 6. The vessel motion may be e.g. 6DOF (Degrees of Freedom) and speed/acceleration in 6DOF (Degrees of Freedom).

Floater instrumentation 7 on the floating wind turbine transfer data related to motion of the floating wind turbine to the vessel winch 6. Motion of the floating wind turbine may be in e.g. 6DOF (Degrees of Freedom) and speed/acceleration in 6DOF (Degrees of Freedom). Floater instrumentation 7 transfer data related to position of the floating wind turbine to vessel DP system 23 and vessel integrated tensioner master system 22. The position of the floating wind turbine may e.g. be in GNS coordinates.

The winch transmits winch operation data to a vessel integrated tensioner master 22. The vessel winch 6 is provided with a winch control system with special enhanced mission execution functionality. The special enhanced mission execution functionality may provide speed setpoints for the winch.

The vessel winch receives information from the vessel integrated tensioner master 22, which may include winch control settings, operational advice, position of FWT, vessel position, integrated failure handling.

The winch receives information of vessel motion from the vessel instrumentation 5, which may include at least one of motion of Vessel in 6D of Freedom and speed/acceleration in 6D of Freedom.

The winch receives information of floater motion from the floater instrumentation 7, which may include at least one of motion of vessel in 6D of Freedom and speed/acceleration in 6D of Freedom.

The installation vessel integrated tensioner master 22 receives information from the instrumentation 7 on the floater, which may include at least the position of the floater. The position of the floater may include motion of floater in 6D of Freedom and speed/acceleration in 6D of Freedom.

The vessel integrated tensioner master 22 may also receive winch operation data from the vessel winch 6.

The vessel integrated tensioner master 22 may also receive information from the vessel DP system 23, which may include at least one of DP system status, DP operational settings and parameters, and vessel position and heading.

The vessel integrated tensioner master 22 may provide information to the installation vessel DP system. This information may include winch parameters, operational limits and advice and integrated failure handling.

The vessel integrated tensioner master 22 may provide information to the vessel winch. The information to the vessel winch may include winch controller settings, operational advice, position of the FWT, position of the installation vessel, integrated failure handling.

The DP system on the installation vessel is provided with a special enhanced mission execution functionality. The DP special enhanced mission execution functionality controls position and heading of the installation vessel based on a number of input parameters.

The DP system receives information from the instrumentation 5 of the installation vessel e.g. of the vessel motion as explained above.

The DP system may also receive information from the instrumentation 7 on the FWT, e.g. information of the FWT position as explained above.

The DP system also receives input parameters from the vessel integrated tensioner master 22. The input parameters from the vessel integrated tensioner master 22 may include winch parameters, operation limits and advice, integrated failure handling.

The DP system provides information to the vessel integrated tensioner master 22, where the information may include DP system status, DP operational settings and parameters, vessel position and heading.

At least one of the winch and the dynamic positioning system on the installation vessel may be controlled based on at least one input parameter for hook-up and tensioning of the at least one mooring line of the floating wind turbine to the seabed. The input parameter may be at least a position of the floating wind turbine and a position of the vessel. The input parameter may be at least a motion of the floating wind turbine and a motion of the vessel. A relative movement between the floating wind turbine and the installation vessel may be compensating during the hook-up and tensioning operation by at least one of the winch or the dynamic positioning system of the installation vessel. Control of at least one of the winch and the dynamic positioning system on the installation vessel may provide control of at least one of a length or a tension or a winch speed of the installation line/mooring line during the hook-up and mooring operation.

By integrating the winch with an optimized winch controller the hook-up and tensioning process can be executed at a higher sea state.

The use of sensor information from the sensor kit 7 installed on the FWT (MRU or RMS) in the controlling software for winches and DP will further improve the functionality and further compensate for the vessel and FWT motions. Integrating the DP into the overall control loop allows the installation vessel to further compensate for relative motion between the installation vessel and the FWT. The capability of controlling the position of the installation vessel integrated with the behaviour of winch, all while in full control of the power utilization, allow the hook-up and tensioning operations to be performed both safer and at a higher seastate.

Integrating the DP into the overall control loop gives the following opportunities:
Increased station keeping accuracy from DP controller
Optimize allocation of power demand, winch and propulsion
Increased safety and reduced risk

The consequences of failure scenarios are reduced with including assistance from DP and winch with built in failure modes: if the winch is defecting the DP could assist and vice versa.

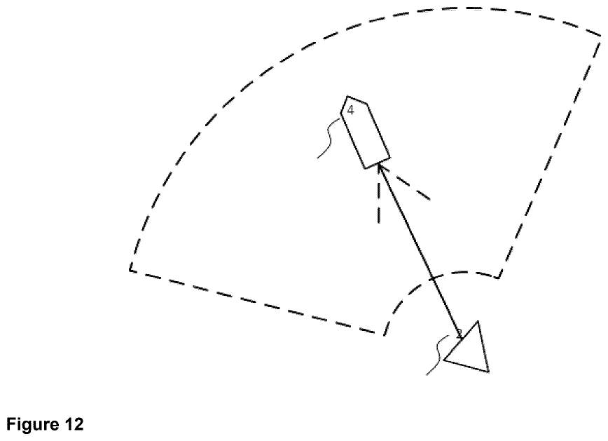

FIG. 12 illustrates an exemplary enhanced DP functionality provided by the vessel integrated tensioner master system. An operation limit in the form of an allowed sector (as illustrated) for the installation vessel is calculated by the vessel integrated tensioner master system and provided to the DP system of the installation vessel. The operational limit is based on requirements for heading and installation line direction to avoid bending of the installation line and structures attached to the floater. The installation line passes from the vessel winch and over the aft of the installation vessel typically in a sheave or guide and the installation line may slip out of this sheave/guide if the heading deviation away from the direction of the installation line to the floater is too large.

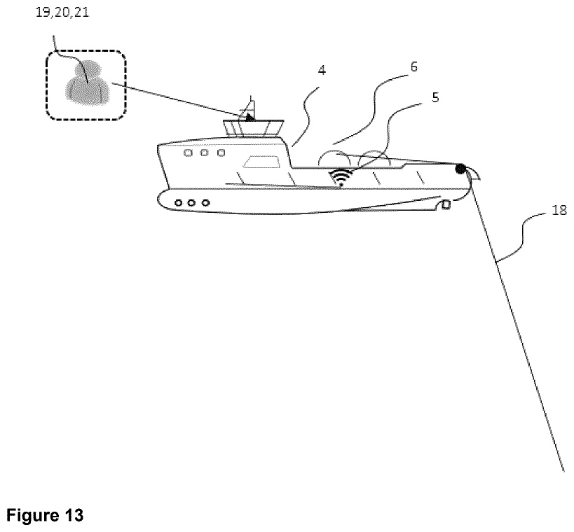

FIG. 13 illustrates an exemplary vessel winch system with a winch HMI, DP HMI and a vessel integrated tensioner master HMI provided on the bridge of the installation vessel.

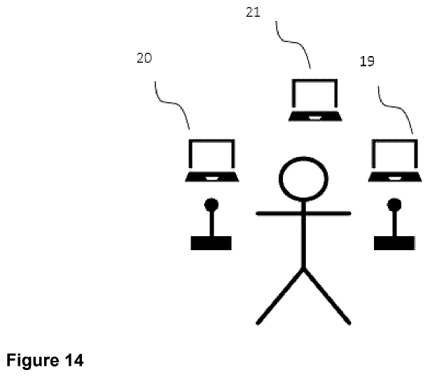

FIG. 14 illustrates an exemplary vessel integrated tensioner master, DP and winch control with human monitor interface (HMI) and at least one human operator for these systems. The human interface provides advice to the human operator of these systems. The integrated tensioner master, DP and winch control systems may also be designed as autonomous systems or semi-autonomous systems. In case of certain failure modes, control of an otherwise human operated system may be taken over by the vessel integrated tensioner master for automatically performing critical operations avoiding disasters.

FIG. 15 illustrates an exemplary vessel tensioner attached to a floating wind turbine. The vessel tensioner 8 is provided with a pawl 24 shown in open position. The vessel tensioner is provided with a hydro acoustic or hydraulic open/closure of the pawl 24.

### EXAMPLES

The following examples serve as illustrations only and are not limiting for the disclosure.

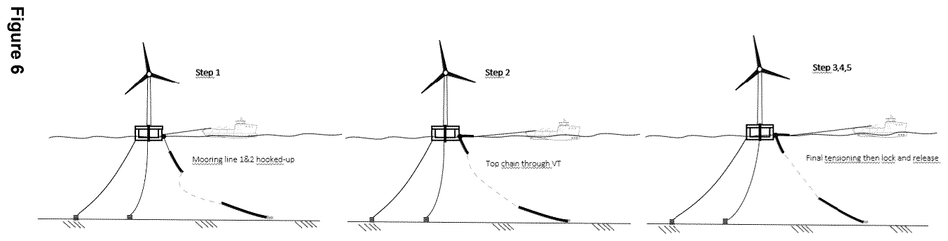

FIG. 6 Hook-up & Tensioning with Vessel Tensioner—Example

The FWT is provided with three mooring lines of which two are already hooked up to the FWT at fixed lengths. The vessel tensioner is connected to the FWT. Hook-up of the third, and last, mooring line via the vessel tensioner may be performed as follows:

The vessel DP maintains a set position or distance to the FWT. The vessel winch actively compensates for weather induced relative motion between vessel and FWT, based on sensor input, to pull in mooring line at steady rate to adjust mooring line tension, and to keep mooring line steady relative to vessel tensioner when locking pawl.

Step 1: Pull-in wire is threaded through the Vessel Tensioner and connected to mooring line in one end and to winch wire in other end. Mooring line is pulled up towards tensioner.

Step 2: Mooring line is pulled through tensioner at a steady rate.

Step 3: Mooring line is tensioned to target tension or target length.

Step 4: Mooring line is kept steady relative to tensioner, and tensioner pawl is closed to lock mooring line length.

Step 5: Winch wire tension released at a steady rate.

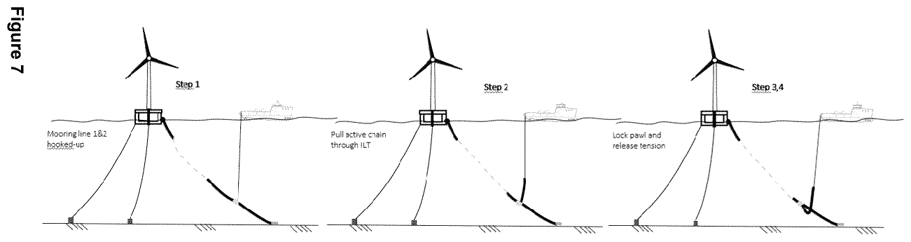

FIG. 7 Hook-up & Tensioning with Inline Tensioner—Example

The FWT is provided with three mooring lines of which two are already hooked up the FWT at fixed lengths. The top segment of the third line may be hooked up to the FWT with an inline tensioner at the other end. The hook-up of the third mooring line may be performed as follows:

The vessel DP maintains a set position or distance to the FWT. The vessel winch actively compensates for weather induced relative motion between vessel and inline tensioner, based on sensor input, to pull in mooring line at steady rate to adjust mooring line tension, and to keep mooring line steady relative to vessel tensioner when locking pawl.

Step 1: Pull-in wire is threaded through the Inline Tensioner and connected to mooring line in one end and to winch wire in other end. Mooring line is pulled up towards tensioner

Step 2: Winch wire and mooring line bottom chain is pulled through tensioner at a steady rate.

Step 3: Mooring line is tensioned to target tension or target length.

Step 4: Mooring line is kept steady relative to tensioner, tensioner pawl is closed, and winch wire tension is released at a steady rate.

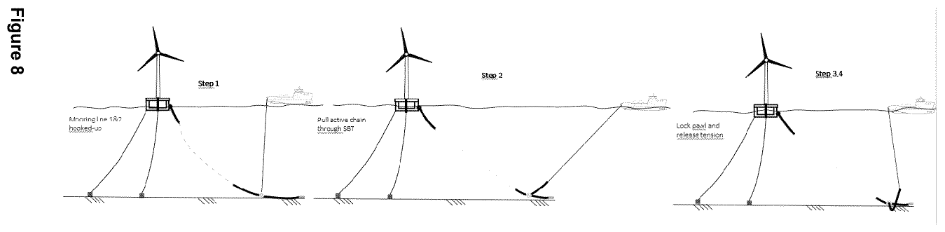

FIG. 8 Hook-up & Tensioning with Seabed Tensioner—Example

The FWT is provided with three mooring lines of which two are already hooked up the FWT at fixed lengths. The top segment of the third line may be hooked up to the FWT with a seabed tensioner at the other end. The hook-up of the third mooring line may be performed as follows:

The vessel DP maintains a set position or distance to the FWT. The vessel winch actively compensates for weather induced relative motion between vessel and seabed tensioner, based on sensor input, to pull in mooring line at steady rate to adjust mooring line tension, and to keep mooring line steady relative to vessel tensioner when locking pawl.

Step 1: Pull-in wire is threaded through the Seabed Tensioner and connected to mooring line in one end and to winch wire in other end. Mooring line is pulled up towards tensioner

Step 2: Winch wire and mooring line bottom chain is pulled through tensioner at a steady rate.

Step 3: Mooring line is tensioned to target tension or target length.

Step 4: Mooring line is kept steady relative to tensioner, tensioner pawl is closed, and winch wire tension is released at a steady rate.

### FIG. 9 Hook-up & Tensioning With Vessel Tensioner & Anchored Installation Vessel—Example

The FWT is provided with three mooring lines of which two are already hooked up to the FWT at fixed lengths. The vessel tensioner is connected to the FWT. Hook-up of the third, and last, mooring line via the vessel tensioner may be performed as follows:

The vessel DP maintains a set position or distance to the FWT when tension in lines towards FWT and reaction anchor is low. When tension is high, the DP fades out thruster force while maintaining heading if required.

The vessel winch actively compensates for weather induced relative motion between vessel and FWT, based on sensor input, to pull in mooring line at steady rate to adjust mooring line tension, and to keep mooring line steady relative to vessel tensioner when locking pawl.

Step 1: Pull-in wire is threaded through the Vessel Tensioner and connected to mooring line in one end and to winch wire in other end. Mooring line is pulled up towards tensioner.

Step 2: Mooring line is pulled through tensioner at a steady rate. Step 3: Mooring line is tensioned to target tension or target length.

Step 4: Mooring line is kept steady relative to tensioner, and tensioner pawl is closed to lock mooring line length.

Step 5: Winch wire tension released at a steady rate.

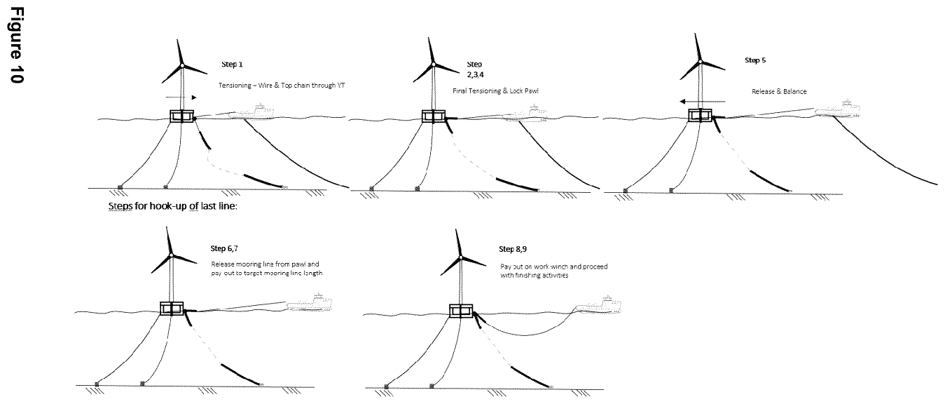

### FIG. 10 Hook-up & Construction Stretch Removing-Vessel Tensioner & Anchored Installation Vessel—Example

The FWT is provided with three mooring lines of which two are already hooked up to the FWT at fixed lengths. The vessel tensioner is connected to the FWT. Hook-up of the third, and last, mooring line via the vessel tensioner may be performed as follows:

The vessel DP maintains a set position or distance to the FWT when tension in lines towards FWT and reaction anchor is low. When tension is high, the DP fades out thruster force while maintaining heading if required.

The vessel winch actively compensates for weather induced relative motion between vessel and FWT, based on sensor input, to pull in mooring line at steady rate to adjust mooring line tension, and to keep mooring line steady relative to vessel tensioner when locking pawl.

Step 1: Pull-in wire is threaded through the Vessel Tensioner and connected to mooring line in one end and to winch wire in other end. Mooring line is pulled up towards tensioner.

Step 2: Mooring line is pulled through tensioner at a steady rate. Step 3: Mooring line is tensioned to target tension or target length.

Step 4: Mooring line is kept steady relative to tensioner, and tensioner pawl is closed to lock mooring line length.

Step 5: Winch wire tension released at a steady rate and FWT re-positions back to its equilibrium position. Removal of CSR is taking place at this step, and it does not involve actions from the integrated tensioner system.

Step 6: Transfer signal to Vessel Tensioner to open pawl. Pay in on work winch to increase tension and effectively shift FWT towards anchored installation vessel.

Step 7: Pull out mooring line from pawl and pay out on work winch until the target pay-out is reached. Mooring line is kept steady relative to tensioner, and tensioner pawl is closed to lock mooring line length.

Step 8: Pay out on winch to enable the disconnection of winch from mooring line.

Step 9: Proceed with finishing activities.

As described in this document, there are pros and cons with the different tensioners, the optimum choice is dependent on several parameters such as design of mooring system, field characteristics, available vessel spread together with requested operability and client preferences.

The winch is connected into the system to ensure constant length of line, pull-in force or velocity. This will reduce the dynamic loads and likely increase installation criteria, hence less waiting of weather. The tensioner may also reduce the required assistance during hook-up due to the pulley block effect.

Another benefit with the upgrade of winch and systems is to optimize the utilisation of available vessel spread and bollard pull. This is related to the compensation behaviour of winch and an increased station keeping accuracy from DP controller. The operational risk is reduced with a more robust operation due to lower probability of failure during installation, e.g., chain stuck in tensioner etc.

The invention includes any one or more of the following embodiment(s) in any combination(s) thereof, but each possible combination is not separately listed in the interests of brevity.

A system for hook-up and tensioning of a floating installation to the seabed, the system comprising: a) a floating installation comprising at least one mooring line adapted for mooring the floating installation to the seabed; b) an installation vessel comprising a dynamic positioning (DP) system and a winch, wherein the winch is adapted for controlling a mooring line/installation line; and c) a tensioner adapted for the mooring line/installation line; wherein the system being adapted for controlling at least one of the winch and the dynamic positioning system on the installation vessel based on at least one input parameter for hook-up and tensioning of the at least one mooring line of the floating installation to the seabed; and a hook-up and tensioning module for controlling a hook-up and tensioning operation for mooring of the floating installation by the installation vessel by use of the tensioner, the module comprising an interface configured to receive data from the dynamic positioning system and the winch on the installation vessel, and a control system configured to adjust the operation of the winch and the dynamic positioning system based on the received data.

Any system herein described, wherein the system is adapted for controlling at least one of the winch and the dynamic positioning system on the installation vessel based on at least a position of the floating installation and a position of the vessel.

Any system herein described, wherein the system is adapted for controlling at least one of the winch and the dynamic positioning system on the installation vessel based on at least a motion of the floating installation and a motion of the vessel.

Any system herein described, wherein the system is adapted for compensating for a relative movement between the floating installation and the installation vessel during the hook-up and tensioning operation by at least one of the winch or the dynamic positioning system of the installation vessel.

Any system herein described, wherein at least one of the winch and the DP system on the installation vessel is adapted for compensating for a relative movement between the floating installation and the installation vessel.

Any system herein described wherein the system is adapted for controlling at least one of the winch and the dynamic positioning system on the installation vessel for controlling at least one of a length or a tension or a winch speed of the installation line/mooring line during the hook-up and mooring operation.

Any system herein described, wherein the floating installation comprising at least one position sensor for measuring a position of the floating installation.

Any system herein described, wherein the floating installation comprising at least one motion sensor for measuring a motion of the floating installation.

Any system herein described, wherein the floating installation comprising a wireless communication system adapted for transmitting sensor information to the installation vessel.

Any system herein described, wherein the installation vessel comprising at least one position sensor for measuring a position of the installation vessel.

Any system herein described, wherein the installation vessel comprising at least one motion sensor for measuring a motion of the installation vessel.

Any system herein described wherein the installation vessel comprising a wireless communication system adapted for receiving sensor information from the floating installation.

Any system herein described, the floating installation further comprising at least one inertial navigation system (INS).

Any system herein described, the floating installation further comprising at least one of a satellite navigation system or an inertial measurement unit (IMU).

Any system herein described, wherein the inertial measurement unit is at least one of a motion reference unit (MRU) and a motion gyro compass (MGC).

Any system herein described, wherein the wireless communication system is a marine broad band radio (MBR).

An installation vessel for performing a hook-up and tensioning operation for mooring at least one mooring line of a floating installation to a seabed by use of a tensioner for the mooring line/installation line, the vessel comprising a dynamic positioning (DP) system and a winch, wherein at least one of the winch and the dynamic positioning system is adapted for controlling the installation line/mooring line of the floating installation based on at least one input parameter for hook-up and tensioning of the at least one mooring line of the floating installation to the seabed

Any installation vessel herein described wherein the installation vessel is adapted for compensating a relative movement between the floating installation and the installation vessel during the hook-up and tensioning operation.

Any installation vessel herein described, wherein the installation vessel is adapted for controlling at least one of the winch and the dynamic positioning system on the installation vessel based on at least a position of the floating installation and a position Any installation vessel herein described, wherein the installation vessel is adapted for controlling the at least one of the winch and the dynamic positioning system on the installation vessel based on at least the motion of the floating installation and the motion of the installation vessel.

Any installation vessel herein described, wherein the installation vessel is adapted for compensating a relative movement between the floating installation and the installation vessel during the hook-up and tensioning operation by at least one of the winch or the dynamic positioning system of the installation vessel.

Any installation vessel herein described, wherein the installation vessel is adapted for controlling at least one of the winch and the dynamic positioning system on the installation vessel for controlling at least one of a length or a tension or a winch speed of the installation line/mooring line during the hook-up and mooring operation.

Any installation vessel herein described, wherein the installation vessel comprising at least one position sensor for measuring a position of the installation vessel.

Any installation vessel herein described, wherein the installation vessel comprising a wireless communication system adapted for receiving sensor information from the floating installation.

Any installation vessel herein described, wherein the sensor information comprising as least one of a position and a motion of the floating installation.

Any installation vessel herein described, wherein the wireless communication system is a marine broad band radio (MBR).

A floating installation comprising: a) at least one mooring line adapted for mooring the floating installation to the seabed; b) at least one sensor; and a) a wireless communication system adapted for transmitting sensor information to an installation vessel adapted for hook-up and tensioning of the at least one mooring line of the floating installation to the seabed.

Any floating installation herein described, wherein the floating installation comprising at least one position sensor for measuring a position of the floating installation.

Any floating installation herein described, wherein the floating installation comprising at least one motion sensor for measuring a motion of the floating installation.

Any floating installation herein described, wherein the floating installation comprising a wireless communication system adapted for transmitting sensor information to the installation vessel.

Any floating installation herein described, the floating installation further comprises at least one inertial navigation system (INS).

Any floating installation herein described, the floating installation further comprises at least one of a satellite navigation system or an inertial measurement unit (IMU).

Any floating installation herein described, wherein the inertial measurement unit is at least one of a motion reference unit (MRU) and a motion gyro compass (MGC).

Any floating installation herein described, wherein wherein the wireless communication system is a marine broad band radio (MBR).

A hook-up and tensioning module for controlling a hook-up and tensioning operation for mooring of a floating installation by an installation vessel by use of a vessel tensioner, the floating installation having at least one mooring line to be moored to the seabed, the module comprising an interface configured to receive data from a dynamic positioning system and a winch on the installation vessel, and a control system configured to adjust the operation of the winch and the dynamic positioning system based on the received data.

Any hook-up and tensioning module herein described, wherein the data comprises at least one input parameter from a floating installation.

Any hook-up and tensioning module herein described, wherein the at least one input parameter from the floating installation comprises a position of the floating installation. Any hook-up and tensioning module herein described, wherein the data comprises winch operation information from the vessel winch.

Any hook-up and tensioning module herein described, wherein the data comprises information from the dynamic positioning system of the installation vessel.

Any hook-up and tensioning module herein described, wherein the control system is adapted for controlling at least one of the winch and the dynamic positioning system on the installation vessel based on at least the position of the floating installation and the position of the vessel for controlling at least one of a length or a tension or a winch speed of the installation line/mooring line during the hook-up and tensioning operation.

A method for hook-up and tensioning of at least one mooring line of a floating installation to a seabed by an installation vessel, the method comprising use of a tensioner and further controlling at least one of a winch and a dynamic positioning system on the installation vessel based on at least one input parameter.

Any method for hook-up and tensioning herein described wherein the method comprising controlling at least one of the winch and the dynamic positioning system on the installation vessel based on at least the position of the floating installation and the position of the vessel.

Any method for hook-up and tensioning herein described wherein method comprising controlling the at least one of the winch and the dynamic positioning system on the installation vessel based on at least the motion of the floating installation and the motion of the vessel.

Any method for hook-up and tensioning herein described wherein the method further comprising compensating a relative movement between the FWT and the installation vessel during the hook-up and tensioning operation by at least one of the winch or the dynamic positioning system of the installation vessel.

Any method for hook-up and tensioning herein described wherein at least one of the winch and the dynamic positioning system on the installation vessel is adapted compensating a relative movement between the floating installation and the installation vessel during the hook-up and tensioning operation.

Any method for hook-up and tensioning herein described wherein the method further comprising controlling at least one of the winch and the dynamic positioning system on the installation vessel for controlling at least one of a length or a tension or a winch speed of the installation line/mooring line during the hook-up and tensioning operation based on at least the position of the floating installation and the position of the vessel.

Having described example embodiments of the invention it will be apparent to those skilled in the art that other embodiments incorporating the concepts may be used. These and other examples illustrated above are intended by way of example only and the actual scope of the invention is to be determined from the following claims.

1. A system for hook-up and tensioning of a floating installation to the seabed, the system comprising:
a floating installation comprising at least one mooring line adapted for mooring the floating wind turbine to the seabed;
an installation vessel comprising a dynamic positioning (DP) system and a winch,
wherein the winch is adapted for controlling a mooring line/installation line; and
a tensioner adapted for the mooring line/installation line;
wherein the system being adapted for controlling at least one of the winch and the dynamic positioning system on the installation vessel based on at least one input parameter for hook-up and tensioning of the at least one mooring line of the floating installation to the seabed; and
a hook-up and tensioning module for controlling a hook-up and tensioning operation for mooring of the floating installation by the installation vessel by use of the tensioner, the module comprising an interface configured to receive data from the dynamic positioning system and the winch on the installation vessel, and a control system configured to adjust the operation of the winch and the dynamic positioning system based on the received data.

2. The system according to claim 1, wherein the system is adapted for controlling at least one of the winch and the dynamic positioning system on the installation vessel based on at least a position of the floating wind turbine and a position of the vessel.

3. The system according to claim 1, wherein the system is adapted for controlling at least one of the winch and the dynamic positioning system on the installation vessel based on at least a motion of the floating wind turbine and a motion of the vessel.

4. The system according to claim 1, wherein the system is adapted for compensating for a relative movement between the floating wind installation and the installation vessel during the hook-up and tensioning operation by at least one of the winch or the dynamic positioning system of the installation vessel.

5. The system according to claim 1, wherein at least one of the winch and the DP system on the installation vessel is adapted for compensating for a relative movement between the floating installation and the installation vessel.

6. The system according to claim 1, wherein the system is adapted for controlling at least one of the winch and the dynamic positioning system on the installation vessel for controlling at least one of a length or a tension or a winch speed of the installation line or the mooring line during the hook-up and mooring operation.

7. The system according to claim 1, wherein the floating installation comprises at least one position sensor for measuring a position of the floating installation.

8. The system according to claim 1, wherein the floating installation comprises at least one motion sensor for measuring a motion of the floating installation.

9. The system according to claim 1, wherein the floating installation comprises a wireless communication system adapted for transmitting sensor information to the installation vessel.

10. The system according to claim 1, wherein the installation vessel comprises at least one position sensor for measuring a position of the installation vessel.

11. The system according to claim 1, wherein the installation vessel comprises at least one motion sensor for measuring a motion of the installation vessel.

12. The system according to claim 1, wherein the installation vessel comprises a wireless communication system adapted for receiving sensor information from the floating installation

13. The system according to claim 1, the floating installation further comprises at least one inertial navigation system (INS).

14. The system according to of claim 1, the floating installation further comprises at least one of a satellite navigation system or an inertial measurement unit (IMU).

15. The system according to claim 14, wherein the inertial measurement unit is at least one of a motion reference unit (MRU) and a motion gyro compass (MGC).

16. The system according to claim 9, wherein the wireless communication system is a marine broad band radio (MBR).

17-35. (canceled)

36. A hook-up and tensioning module for controlling a hook-up and tensioning operation for mooring of a floating installation by an installation vessel by use of a vessel tensioner, the floating installation having at least one mooring line to be moored to the seabed, the module comprising an interface configured to receive data from a dynamic positioning system and a winch on the installation vessel, and a control system configured to adjust the operation of the winch and the dynamic positioning system based on the received data.

37. The hook-up and tensioning module according to claim 36, wherein the data comprises at least one input parameter from a floating installation.

38. The hook-up and tensioning module according to claim 37, wherein the at least one input parameter from the floating installation comprises a position of the floating installation.

39. The hook-up and tensioning module according to claim 36, wherein the data comprises winch operation information from the vessel winch.

40. The hook-up and tensioning module according to claim 36, wherein the data comprises information from the dynamic positioning system of the installation vessel.

41. The hook-up and tensioning module according to claim 36, wherein the control system is adapted for controlling at least one of the winch and the dynamic positioning system on the installation vessel based on at least the position of the floating installation and the position of the vessel for controlling at least one of a length or a tension or a winch speed of the installation line or the mooring line during the hook-up and tensioning operation.

42-47. (canceled)
